(19) United States
(12) Patent Application Publication
(10) Pub. No.: US 2024/0343338 A1
(43) Pub. Date: Oct. 17, 2024

(54) FRONT FORK

(71) Applicant: KYB Motorcycle Suspension Co.,Ltd., Gifu (JP)

(72) Inventors: Osamu MIYAZAKI, Gifu (JP); Kei SUZAKI, Gifu (JP)

(73) Assignee: KYB Motorcycle Suspension Co.,Ltd., Gifu (JP)

(21) Appl. No.: 18/292,583

(22) PCT Filed: Dec. 20, 2021
(86) PCT No.: PCT/JP2021/047059

§ 371 Date: Jan. 26, 2024

(51) Int. Cl. B62K 25/08

(52) U.S. Cl. CPC B62K 25/08

(57) ABSTRACT

A front fork (1) includes: a fork main body (2) that includes a tube member (3) including a vehicle body side tube (3a) and an axle side tube (3b), and a suspension spring (4) that biases the tube member (3) in a stretching direction; a cap (5) that includes a cylindrical portion (5a) and a lid portion (5b) continuing to the outer circumference of the cylindrical portion (5a), and closes the opening end of the vehicle body side tube (3a); a washer (6) that supports the upper end of the suspension spring (4); an adjuster (7) that includes a shaft portion (7a) screwed to the washer (6), a flange portion (7b) provided at the rear end of the shaft portion (7a), and an operation shaft portion 7c extending from an opposite shaft portion side of the flange portion (7b), and that is rotatably inserted into the cylindrical portion 5a; and a stopper member (8) that is placed on the inner circumference of the cylindrical portion (5a) and prevents the adjuster (7) from being detached from the cap (5).

### TECHNICAL FIELD

The present invention relates to a front fork.

### BACKGROUND ART

Some front fork that supports front wheels of a straddle vehicle is interposed between a vehicle body and a front wheel axle of the straddle vehicle to exert a damping force. Such a front fork is generally configured to include a fork main body that includes a vehicle body side tube connected to a vehicle body of a straddle vehicle and an axle side tube fitted to the vehicle body side tube and connected to a front wheel axle, and stretches and contracts, a damper cartridge that includes a cylinder and a rod, is accommodated in a fork main body, and exerts a damping force accompanying extension and contraction of the fork main body, and a suspension spring that biases the damper cartridge and the fork main body to extend.

The above front fork may include an adjuster for adjusting a support position of the upper end of the suspension spring to a cap that closes the upper end of the vehicle body side tube to enable adjustment of the vehicle height of the straddle vehicle to the vehicle height desired by the user (see, for example, Patent Literature 1).

This front fork includes an annular lid portion at which a cap is screwed to a female screw portion formed on the inner circumference of the vehicle body side tube, and a cylindrical portion that is suspended from the inner circumference of the lid portion, and has an opening on a side. Furthermore, the lower end of the cylindrical portion is connected to the rod of the damper cartridge, and a screw portion is provided on the inner circumference of the cylindrical portion and above the opening.

On the other hand, the adjuster includes a male screw portion that is screwed to the female screw portion of the cylindrical portion on the outer circumference and from the distal end to the center, and moves in and out of the cylindrical portion in a manner of a feed screw by a user's rotation operation. Furthermore, a C-ring is placed on the outer circumference of the distal end of the adjuster, and, when the adjuster moves in an upper direction in which the adjuster moves out of the cylindrical portion by the rotation operation, and retreats from the cylindrical portion at maximum, the C-ring comes into contact with the lower end of the female screw portion to regulate the adjuster from further retreating.

Furthermore, the cylindrical portion accommodates a spring seat that includes a main body portion inserted into the cylindrical portion and a spring support portion that extends from the main body portion, protrudes from the opening of the cylindrical portion to the outside of the cylindrical portion, and supports the upper end of the suspension spring, and the lower end of the adjuster comes into contact with the main body portion of the spring seat. Therefore, when the user performs an operation of rotating the adjuster, the adjuster moves up and down with respect to the cap, the spring seat follows the upward and downward movement of the adjuster, a support position of the upper end of the suspension spring is changed, and the vehicle height of the straddle vehicle is adjusted.

In this conventional front fork, when the user performs the operation of rotating the adjuster, the adjuster is displaced in an upward/downward direction with respect to the cap, and the adjuster is likely to interfere with a handle, instruments, and the like in the straddle vehicle having a layout in which the handle, the instruments, and the like are disposed just above the front fork.

Therefore, it is desired to adopt a structure that a screw hole is provided to the main body portion of the spring seat, the spring seat is screwed to the male screw portion of the adjuster, and only the spring seat is moved up and down with respect to the cap in the manner of the feed screw by the rotation operation of the adjuster.

In this case, there is adopted a structure that a flange is provided on the outer circumference of the adjuster, the cap is formed by two parts, and one of the parts that form the cap supports the flange of the adjuster from the upper side to prevent the adjuster from being detached.

More specifically, as illustrated in FIG. 6, a cap 100 includes a lid member 101 that includes an outer tube 101a screwed to the inner circumference of a vehicle body side tube 50, an inner tube 101b including a male screw portion 101c on the outer circumference, and an annular plate 101d connecting the outer tube 101a and the inner tube 101b, and a cylindrical member 102 that is screwed to the outer circumference of the inner tube 101b of the lid member 101 and connected to the upper end of a rod 51. Furthermore, an adjuster 103 includes a flange 103b on the outer circumference of an intermediate portion and above a male screw portion 103a, and is rotatably inserted into the inner tube 101b of the lid member 101. Furthermore, the flange 103b of the adjuster 103 is in contact with a step portion 101e formed on the inner circumference of the inner tube 101b, and is kept in a state where the flange 103b is in contact with the step portion 101e of the inner tube 101b by an elastic force from a suspension spring 52. The male screw portion 103a of the adjuster 103 is screwed to a spring seat 104 that includes a screw hole and supports the upper end of the suspension spring 52, and the spring seat 104 moves in the upper/lower direction by a rotation operation of the adjuster 103.

In the front fork formed in this way, the adjuster 103 does not move up and down with respect to the cap 100, so that it is possible to naturally use the front fork for a straddle vehicle having a layout in which a handle, instruments, and the like are disposed just above the front fork.

### CITATION LIST

### Patent Literature

Patent Literature 1: JP 2012-112452 A

### SUMMARY OF INVENTION

### Technical Problem

However, in the front fork, the cap 100 is formed by the two parts of the lid member 101 and the cylindrical member 102, and are connected by thread fastening, and therefore it is necessary to secure an overlap margin at a thread fastening portion between the cylindrical member 102 and the inner tube 101b of the lid member 101.

Furthermore, an opening 102a that is provided to the cylindrical member 102 and through which a spring support portion 104a of the spring seat 104 is inserted needs to be provided avoiding a screw portion 102b of the cylindrical member 102 downward, therefore the entire length of the cylindrical member 102 inevitably becomes long, and the support position of the suspension spring 52 of the spring seat 104 also shifts downward by the entire length.

Then, when the support position of the suspension spring 52 of the spring seat 104 shifts downward, an axial length (storage length) in a space in which the suspension spring 52 is installed becomes shorter by the shift amount. When the storage length becomes short, a problem occurs that the degree of design freedom of the suspension spring 52 lowers by the storage length.

It is therefore an object of the present invention is to provide a front fork that can shorten the entire length of a cap, and improve the degree of design freedom of a suspension spring.

### Solution to Problem

To achieve the above object, a front fork according to the present invention employs a configuration including: a fork main body that includes a tube member that is formed by slidably fitting a vehicle body side tube and an axle side tube, and a suspension spring that biases the tube member in a stretching direction; a cap that includes a cylindrical portion inserted into the vehicle body side tube and including an opening at a side portion on a distal end side, and an annular lid portion continuing to an outer circumference of the cylindrical portion and placed in an end portion of the vehicle body side tube, and that closes an opening end of the vehicle body side tube; a washer that includes a nut portion having an annular shape, inserted into the cylindrical portion, and including a screw portion on an inner circumference, and an arm portion that extends from an outer circumference of the nut portion, protrudes to an outside of the cylindrical portion through the opening, and supports an upper end of the suspension spring; an adjuster that includes a shaft portion including a screw groove formed on an outer circumference and screwed to the nut portion, a flange portion provided at a rear end of the shaft portion, and an operation shaft portion extending from an opposite shaft portion side of the flange portion and including an operation portion at a distal end, and that is inserted into the cylindrical portion of the cap from a side of the shaft portion, is rotatable in a circumferential direction with respect to the cap, and causes the operation portion to protrude upward from the cylindrical portion; and a stopper member that is placed on an inner circumference of the cylindrical portion of the cap, and comes into contact with the opposite shaft portion side of the flange portion to prevent the adjuster from being detached from the cap.

In the front fork employing the above configuration, the cap is formed by only one part instead of two parts, and there is no thread fastening portion for performing thread fastening on the two parts together, so that it is possible to place a position of the opening through which the arm portion of the washer is inserted upward compared to a conventional front fork.

In this way, by arranging the position of the opening of the cap upward, it is possible to shift the support position of the upper end of the suspension spring supported by the arm portion of the washer upward compared to the conventional front fork, so that it is possible to shorten the entire length of the cap by the shift amount, and increase the storage length in the space in which the suspension spring is installed in the front fork.

### BRIEF DESCRIPTION OF DRAWINGS

FIG. 1 is a longitudinal cross-sectional view of a front fork according to an embodiment of the present invention.

FIG. 2 is an enlarged longitudinal cross-sectional view of an upper end of the front fork according to the embodiment of the present invention.

FIG. 3 is an enlarged longitudinal cross-sectional view of the upper end of the front fork according to a first modified example of the embodiment of the present invention.

FIG. 4 is an enlarged longitudinal cross-sectional view of the upper end of the front fork according to a second modified example of the embodiment of the present invention.

FIG. 5 is an enlarged longitudinal cross-sectional view of the upper end of the front fork according to a third modified example of the embodiment of the present invention.

FIG. 6 is an enlarged longitudinal cross-sectional view of the upper end of a conventional front fork.

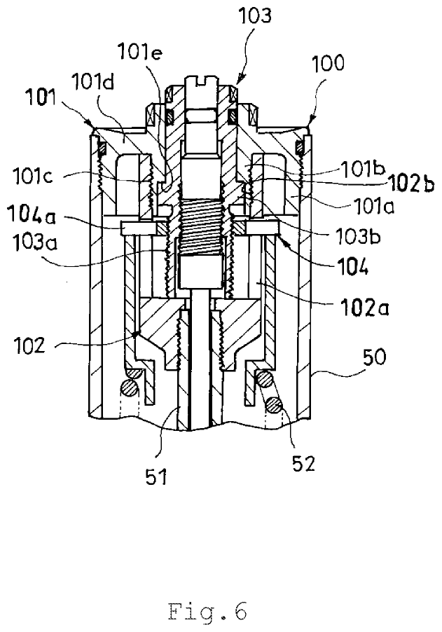

### DESCRIPTION OF EMBODIMENTS

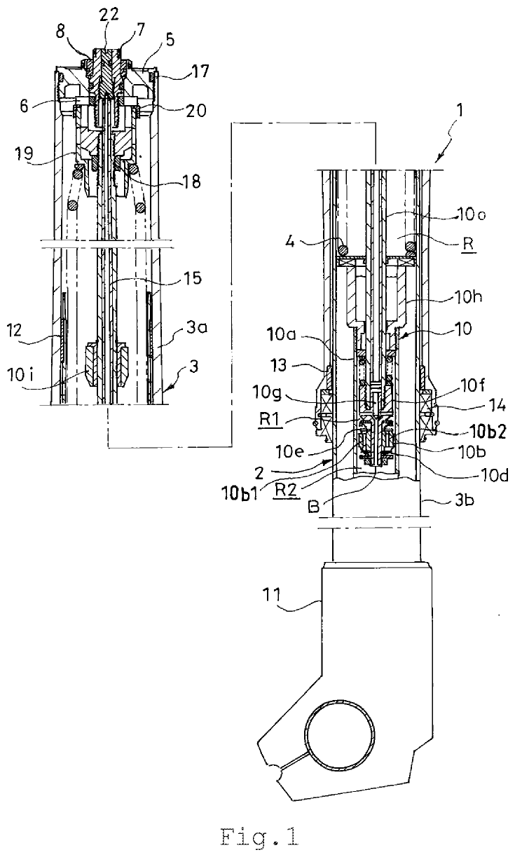

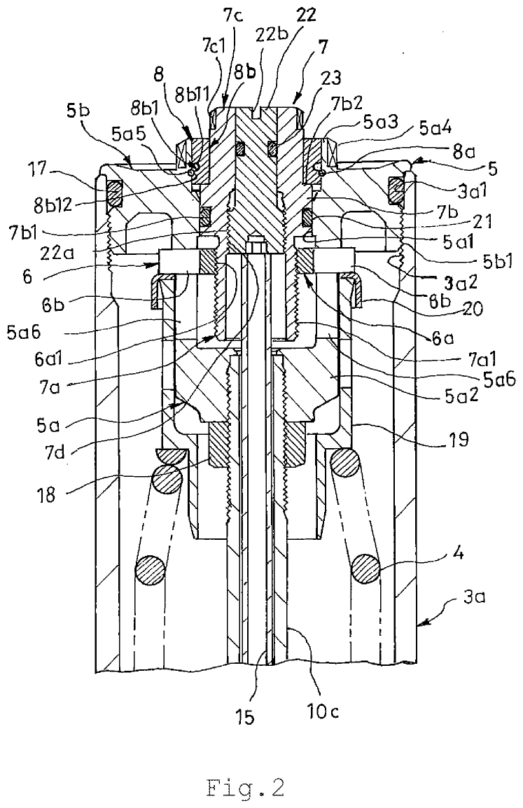

Hereinafter, the present invention will be described based on an embodiment illustrated in the drawings. As illustrated in FIGS. 1 and 2, a front fork 1 according to the present invention includes: a fork main body 2 including a tube member 3 formed by slidably fitting a vehicle body side tube 3a and an axle side tube 3b, and a suspension spring 4 that biases the tube member 3 in a stretching direction; a cap 5 that includes a cylindrical portion 5a and a lid portion 5b and closes an opening end 3a1 of the vehicle body side tube 3a; a washer 6 that is inserted into the cylindrical portion 5a; an adjuster 7 that is inserted into the cylindrical portion 5a and screwed to the washer 6; and a stopper member 8 that prevents the adjuster 7 from being detached from the cap 5.

Each unit will be described below. As illustrated in FIG. 1, the fork main body 2 includes the tube member 3 and the suspension spring 4, and includes a damper cartridge 10 that stretches and contracts accompanying stretch and contraction of the tube member 3 to exert a damping force. The tube member 3 includes the vehicle body side tube 3a that is disposed on the upper side and connected to a vehicle body of an unillustrated straddle vehicle, and the axle side tube 3b that has the diameter smaller than that of the vehicle body side tube 3a, is disposed on the lower side, and is inserted into the vehicle body side tube 3a. Furthermore, the tube member 3 stretches and contracts when the vehicle body side tube 3a and the axle side tube 3b relatively move in an axial direction. Note that the upper end of the vehicle body side tube 3a is closed by the cap 5, and the lower end of the axle side tube 3b is closed by a bottom cap 11 that grips an axle of front wheels of the unillustrated straddle vehicle. Furthermore, annular bearings 12 and 13 are provided between the vehicle body side tube 3a and the axle side tube 3b, and the vehicle body side tube 3a and the axle side tube 3b are smoothly movable in the axial direction. Furthermore, an annular seal member 14 that is slidably in contact with the outer circumference of the axle side tube 3b is provided on the inner circumference of the lower end of the vehicle body side tube 3a, and the internal space of the tube member 3 is sealed.

The damper cartridge 10 stretches and contracts accompanying stretch and contraction of the tube member 3 to exert a damping force. The damper cartridge 10 includes a cylinder 10a that is fixed to the bottom cap 11 that closes an opening portion of the lower end of the axle side tube 3b, a piston 10b that is slidably inserted into the cylinder 10a to partition the inside of the cylinder 10a into an extension side chamber R1 and a compression side chamber R2 filled with a liquid, and a piston rod 10c that is connected to the piston 10b, inserted into the cylinder 10a movably in the axial direction, and connected to the cap 5 that closes the opening portion of the upper end of the vehicle body side tube 3a. Furthermore, an annular gap formed between the damper cartridge 10 and the tube member 3 is used as a reservoir R filled with a liquid and a gas, and communicates with the compression side chamber R2 through unillustrated holes provided to this reservoir R and the cylinder 10a. Hence, a liquid corresponding to the volume pushed out in the cylinder 10a by the piston rod 10c moving in and out of the cylinder 10a at a time of extension and contraction is exchanged between the inside of the cylinder 10a and the reservoir R, so that the volume can be compensated for. Note that, as the liquid, a hydraulic oil can be used, and, in addition, any liquid that can exert the damping force can be used.

Furthermore, the piston 10b includes an extension side port 10b1 and a compression side port 10b2 that have annular shapes, and make the extension side chamber R1 and the compression side chamber R2 communicate with each other. Furthermore, an annular extension side leaf valve 10d that opens and closes the extension side port 10b1 is laminated at the lower end of the piston 10b in FIG. 1, and an annular compression side leaf valve 10e that opens and closes the compression side port 10b2 is laminated at the upper end of the piston 10b in FIG. 1. These piston 10b, extension side leaf valve 10d, and compression side leaf valve 10e are placed together to the outer circumference of a piston connecting member 10f connected to the lower end of the piston rod 10c in FIG. 1. The inner circumference sides of the extension side leaf valve 10d and the compression side leaf valve 10e are fixed to the piston rod 10c, and, when the outer circumference sides deflect and move apart from the piston 10b, the corresponding extension side port 10b1 and compression side port 10b2 are opened.

The piston rod 10c has a cylindrical shape, and has the upper end in FIG. 1 connected to the cap 5 by thread fastening. The piston connecting member 10f connected to the lower end of the piston rod 10c in FIG. 1 has a tubular shape, has the outer circumference to which the piston 10b, the extension side leaf valve 10d, and the compression side leaf valve 10e are placed, and, in addition, forms a bypass passage B that makes the extension side chamber R1 and the compression side chamber R2 communicate with each other through the inner circumference detouring the extension side port 10b1 and the compression side port 10b2. Furthermore, a needle valve 10g is inserted into the piston connecting member 10f movably in the axial direction. The needle valve 10g moves in the axial direction in the piston connecting member 10f to increase or decrease a flow passage area of the bypass passage B.

Furthermore, a cylindrical rod guide 10h into which the piston rod 10c is slidably inserted is placed to the inner circumference of the upper end of the cylinder 10a. The rod guide 10h plays a role of guiding movement in the axial direction of the piston rod 10c, and, in addition, functions as a spring seat that supports the lower end of the suspension spring 4, and also functions as an oil lock case that suppresses further contraction of the damper cartridge 10 and the fork main body 2 caused by entry of an oil lock piece 10i provided on the outer circumference in the middle of the piston rod 10c.

Furthermore, an adjustment rod 15 is inserted into the piston rod 10c movably in the axial direction. As illustrated in FIG. 1, the lower end of the adjustment rod 15 is in contact with the upper end of the needle valve 10g, and, when the adjustment rod 15 is moved up and down, the needle valve 10g also moves up and down, so that it is possible to adjust the flow passage area in the bypass passage B. Note that where the bypass passage B is provided is not limited to the needle valve 10g, and a variable damping valve that is displaced in the bypass passage B by the adjustment rod 15 to make the flow passage area or the valve opening pressure variable can be used.

In the front fork 1 formed as described above, when the fork main body 2 extends, the damper cartridge 10 also extends, and the extension side chamber R1 is compressed by the piston 10b. Furthermore, when the extension speed of the fork main body 2 is low, and the pressure of the extension side chamber R1 does not reach a pressure for opening the extension side leaf valve 10d, the liquid in the extension side chamber R1 moves to the compression side chamber R2 through the bypass passage B in a state where the needle valve 10g is opened. The needle valve 10g gives resistance to the flow of this liquid, so that a difference is produced between pressures of the extension side chamber R1 and the compression side chamber R2, and the front fork 1 exerts a damping force for suppressing the extension operation. Furthermore, in a state where the extension speed of the fork main body 2 becomes high, the pressure of the extension side chamber R1 acts to open the extension side leaf valve 10d and the needle valve 10g is opened, the liquid in the extension side chamber R1 moves to the compression side chamber R2 through not only the bypass passage B but also the extension side port 10b1. The needle valve 10g and the extension side leaf valve 10d give resistance to the flow of this liquid, so that a difference is produced between the pressures of the extension side chamber R1 and the compression side chamber R2, and the front fork 1 exerts the damping force for suppressing the extension operation.

Here, it is possible to change the valve opening degree of the needle valve 10g by moving the adjustment rod 15 in the axial direction, so that it is possible to adjust the property of the damping force (the property of the damping force with respect to the extension/contraction speed) on the extension side of the front fork 1.

Furthermore, when the fork main body 2 contracts, the damper cartridge 10 also contracts, and the compression side chamber R2 is compressed by the piston 10b.

Furthermore, in a case where the contraction speed of the fork main body 2 is low, and the pressure of the compression side chamber R2 does not reach the valve opening pressure of the compression side leaf valve 10e, the liquid in the compression side chamber R2 moves to the extension side chamber R1 through the bypass passage B in a state where the needle valve 10g is opened. The needle valve 10g gives resistance to the flow of this liquid, so that a difference is produced between the pressures of the extension side chamber R1 and the compression side chamber R2, and the front fork 1 exerts the damping force for suppressing the contraction operation. Furthermore, in a state where the contraction speed of the fork main body 2 becomes high, and the pressure of the compression side chamber R2 reaches the valve opening pressure of the compression side leaf valve 10e, the liquid in the compression side chamber R2 moves to the extension side chamber R1 through not only the bypass passage B but also the compression side port 10b2 in a state where the needle valve 10g is opened. The needle valve 10g and the compression side leaf valve 10e give resistance to the flow of this liquid, so that a difference is produced between the pressures of the extension side chamber R1 and the compression side chamber R2, and the front fork 1 exerts the damping force for suppressing the contraction operation.

Furthermore, even at a time of the contraction operation of the front fork 1, it is possible to increase or decrease the flow passage area of the bypass passage B by displacing and adjusting the needle valve 10g by the adjustment rod 15, and adjust the damping force on the compression side of the front fork 1.

Next, the cap 5, the washer 6 placed in the cap 5, the adjuster 7, and the stopper member 8 will be described in detail. As illustrated in FIG. 2, the cap 5 includes the cylindrical portion 5a that is inserted into the vehicle body side tube 3a and has an opening at the side portion on the distal end side, and the annular lid portion 5b that continues to the outer circumference of the cylindrical portion 5a and is placed in the end portion of the vehicle body side tube 3a.

The cylindrical portion 5a has a bottomed cylindrical shape, and includes a small-diameter portion 5a2 that is formed at the lower end and has the inner diameter smaller than that of an intermediate portion 5a1, and a large-diameter portion 5a3 that is formed at the upper end and has the inner diameter larger than that of the intermediate portion 5al. A screw groove is formed on the inner circumference of the small-diameter portion 5a2, and a screw groove provided on the outer circumference of the upper end of the piston rod 10c in the damper cartridge 10 is screwed thereto. Note that a nut 18 is screwed to the screw groove on the outer circumference of the upper end of the piston rod 10c and comes into contact with the lower end of the cylindrical portion 5a, and the small-diameter portion 5a2 and the nut 18 fasten each other and are prevented from slacking, so that the cylindrical portion 5a and the piston rod 10c are fastened fast.

The large-diameter portion 5a3 includes a hexagonal grip portion 5a4 that can be gripped by a tool, on the outer circumference of the upper end, and includes an annular groove 5a5 on the inner circumference along the circumferential direction. Furthermore, the intermediate portion 5a1 of the cylindrical portion 5a is provided with a pair of rectangular openings 5a6 that face each other with a phase difference of 180 degrees.

The lid portion 5b protrudes in a flange shape from the side near the upper end of the cylindrical portion 5a toward the outer circumference side, and includes a screw portion 5b1 on the outer circumference. The lid portion 5b is connected to the vehicle body side tube 3a by screwing the screw portion 5b1 of the outer circumference to a screw portion 3a2 formed on the inner circumference of the opening end 3al at the upper end of the vehicle body side tube 3a. Furthermore, a seal ring 17 closely adhered to the inner circumference of the vehicle body side tube 3a is placed on the outer circumference of the lid portion 5b and above the screw portion 5b1, and the cap 5 and the vehicle body side tube 3a are sealed.

The washer 6 includes an annular nut portion 6a that includes a screw groove 6a1 on the inner circumference, and a pair of arm portions 6b that extend from the outer circumference of the nut portion 6a and protrude to the outside of the cylindrical portion 5a through the opening 5a6 of the cylindrical portion 5a. The washer 6 is movable in the upper/lower direction with respect to the cap 5 within a range in which the arm portion 6b can move in the upper/lower direction in the opening 5a6 in the cylindrical portion 5a. Note that the arm portion 6b of the washer 6 is slidably inserted into the opening 5a6 of the cylindrical portion 5a, and the washer 6 can move in the upper/lower direction in the cylindrical portion 5a, yet is regulated from rotating about the nut portion 6a in the circumferential direction.

Note that a cylindrical spacer 19 fitted to the upper end of the suspension spring 4 is disposed on the outer circumference of the cylindrical portion 5a, and a spacer 20 is laminated at the upper end of the spacer 19 rotatably with respect to the spacer 19. Furthermore, the arm portion 6b of the washer 6 is in contact with the upper end of the spacer 20, and supports the upper end of the suspension spring 4 with the spacer 19 and the spacer 20 interposed therebetween. The suspension spring 4 is interposed in a compressed state between the rod guide 10h of the damper cartridge 10 and the washer 6.

The adjuster 7 has a cylindrical shape as a whole, includes a shaft portion 7a on a lower side, a flange portion 7b provided on the outer circumference of the upper end in FIG. 2 that is the rear end of the shaft portion 7a, and an operation shaft portion 7c provided above the flange portion 7b, and is inserted into the cylindrical portion 5a of the cap 5 rotatably in the circumferential direction.

The shaft portion 7a has the outer circumference on which a screw groove 7al to be screwed to the nut portion 6a of the washer 6 is formed. The flange portion 7b is provided from the upper end of the shaft portion 7a in FIG. 2 toward the outer circumference side, and includes an annular groove 7b1 on the outer circumference along the circumferential direction in which the seal ring 21 is accommodated. An end surface 7b2 on the upper side in FIG. 2 that is an opposite shaft portion side of the flange portion 7b is a smooth orthogonal surface orthogonal to the axis of the adjuster 7. When the adjuster 7 is inserted at an appropriate position in the cylindrical portion 5a, the seal ring 21 is slidably in contact with the inner circumferential surface of the cylindrical portion 5a above the opening 5a6 of the intermediate portion 5al to seal between the adjuster 7 and the cylindrical portion 5a.

The operation shaft portion 7c extends upward from the upper end side in FIG. 2 that is the opposite shaft portion side of the flange portion 7b, and includes at the distal end an operation portion 7c1 that can be gripped by a tool. Furthermore, when the adjuster 7 is inserted at the appropriate position in the cylindrical portion 5a, the operation portion 7c1 protrudes from the cylindrical portion 5a, and is exposed to the outside of the front fork.

The adjuster 7 formed as described above can be inserted into the cylindrical portion 5a of the cap 5 from the shaft portion 7a side, and rotate in the circumferential direction with respect to the cap 5. Consequently, the user can grip the operation portion 7c1 using the tool, and easily perform an operation of rotating the adjuster 7. The outer circumferential shape of the operation portion 7c1 is the hexagonal shape, yet may be a shape other than the hexagonal shape suitable for the tool to grip.

Note that a screw groove 7d is provided on the inner circumference of the adjuster 7. Furthermore, an operator 22 that comes into contact with the upper end of the adjustment rod 15 in FIG. 2 is rotatably inserted into the inner circumference of the adjuster 7. The operator 22 includes a screw portion 22a that is screwed to the screw groove 7d on the outer circumference of the lower end in FIG. 2, and moves in the upper/lower direction that is the axial direction with respect to the adjuster 7 when rotated by an operation of the tool inserted into a groove 22b provided at a head portion. By rotating the operator 22 with respect to the adjuster 7 in this way, it is possible to adjust the opening degree of the needle valve 10g via the adjustment rod 15, and adjust the damping force generated by the damper cartridge 10. Note that a seal ring 23 placed on the outer circumference of the operator 22 seals between the operator 22 and the adjuster 7.

Subsequently, the stopper member 8 is placed on the inner circumference of the large-diameter portion 5a3 of the cylindrical portion 5a of the cap 5, and comes into contact with the end surface 7b2 on the opposite shaft portion side of the flange portion 7b of the adjuster 7 to prevent the adjuster 7 from being detached from the cap 5. As described above, the stopper member 8 is placed on the inner circumference of the opening end at the upper side of the cylindrical portion 5a of the cap 5.

More specifically, the stopper member 8 includes a C-shaped ring 8a that is inserted into the annular groove 5a5 provided to the inner circumference of the large-diameter portion 5a3 of the cylindrical portion 5a, and a stopper 8b that has the annular shape, is inserted between the cylindrical portion 5a and the operation shaft portion 7c and regulated by the ring 8a from moving upward with respect to the cylindrical portion 5a, and comes into contact with the end surface 7b2 on the opposite shaft portion side of the flange portion 7b.

The ring 8a has the outer diameter set to the diameter of the bottom portion of the annular groove 5a5 of the cylindrical portion 5a or more, can be inserted into the cylindrical portion 5a when the outer diameter is reduced, expands the diameter by a restoring force for widening the outer diameter of the ring 8a when the outer diameter is reduced and then the ring 8a is inserted into the annular groove 5a5, and is fixed to the annular groove 5a5.

The stopper 8b is an annular part having a rectangular cross section, can be inserted into an annular gap between the large-diameter portion 5a3 of the cylindrical portion 5a and the operation shaft portion 7c of the adjuster 7, and is slidably in contact with both of the large-diameter portion 5a3 and the operation shaft portion 7c. Furthermore, the stopper 8b includes an annular recess portion 8b1 that accommodates the ring 8a on the outer circumference. Furthermore, the axial length of the stopper 8b is shorter than the axial length of the large-diameter portion 5a3. In the front fork 1 according to the present embodiment, the annular recess portion 8b1 includes a first groove portion 8b11 that has the inner diameter smaller than the inner diameter of the ring 8a and has the depth equal to or larger than the wire diameter of the ring 8a, and a second groove portion 8b12 that is adjacent to the lower side of the first groove portion 8b11 and has the depth less than the wire diameter of the ring 8a. Furthermore, the first groove portion 8b11 has the axial width equal to or larger than the wire diameter of the ring 8a, and can completely accommodate the ring 8a. Note that the axial width of the second groove portion 8b12 is preferably set to the width that is ½ or more of the wire diameter of the ring 8a. In a case where the axial width of the second groove portion 8b12 is set to the width that is ½ or more of the wire diameter of the ring 8a, the outermost circumference of the ring 8a can be supported by the bottom portion of the second groove portion 8b12 even when an external force for reducing the diameter of the ring 8a acts, so that it is possible to effectively prevent reduction of the diameter of the ring 8a.

The stopper 8b is prevented from being detached from the cylindrical portion 5a by the ring 8a placed in the annular groove 5a5 of the large-diameter portion 5a3 of the cylindrical portion 5a and disposed in the second groove portion 8b12 of the annular recess portion 8b1.

The lower end surface of the stopper 8b is a smooth orthogonal surface orthogonal to the axis of the adjuster 7, and, when the lower end surface of the stopper 8b comes into contact with the end surface 7b2 on the opposite shaft portion side of the flange portion 7b, supports the flange portion 7b while allowing smooth rotation of the adjuster 7, and prevents the adjuster 7 from being detached from the cylindrical portion 5a.

Furthermore, to place the stopper member 8 in the cylindrical portion 5a of the cap 5, the washer 6 is first inserted into the cylindrical portion 5a, then the adjuster 7 is inserted into the cylindrical portion 5a, and the shaft portion 7a is screwed to the nut portion 6a of the washer 6. Note that, at this time, the operator 22 is assembled to the inner circumference of the adjuster 7 in advance, and is inserted into the cylindrical portion 5a together with the adjuster 7 when the adjuster 7 is inserted into the cylindrical portion 5a.

Furthermore, while a crack of the ring 8a is widened to expand the diameter, the ring 8a is caused to face the first groove portion 8b11 in the annular recess portion 8b1 of the stopper 8b, and then the diameter of the ring 8a is reduced. Then, the ring 8a is completely accommodated in the first groove portion 8b11 of the stopper 8b.

The stopper member 8 in the above state is inserted into an annular gap between the cylindrical portion 5a of the cap 5 and the operation shaft portion 7c of the adjuster 7. When the ring 8a is inserted into the large-diameter portion 5a3 of the cylindrical portion 5a together with the stopper 8b, expansion of the diameter of the ring 8a is prevented by the inner circumference of the large-diameter portion 5a3 until the ring 8a faces the annular groove 5a5, and therefore the ring 8a is inserted into the large-diameter portion 5a3 together with the stopper 8b in a state where the diameter is reduced.

When the stopper 8b is gradually inserted in the large-diameter portion 5a3, the degree of insertion of the stopper 8b into the large-diameter portion 5a3 progresses, and the ring 8a finally faces the annular groove 5a5, the diameter of the ring 8a is expanded, and the ring 8a enters the annular groove 5a5, and is fixed to the cylindrical portion 5a. When the ring 8a is inserted into the annular groove 5a5, the ring 8a comes into contact with the side surface at the upper side of the first groove portion 8b11 in FIG. 2, and makes it impossible to further push the stopper 8b into the cylindrical portion 5a. Note that the stopper 8b and the flange portion 7b may come into contact with each other at the time of insertion of the stopper member 8 into the annular gap between the cylindrical portion 5a and the adjuster 7. Since the adjuster 7 supports the upper end of the suspension spring 4 together with the washer 6, the suspension spring 4 contracts according to the degree of insertion of the stopper member 8 into the cylindrical portion 5a, so that, even when the stopper 8b and the flange portion 7b come into contact with each other, the stopper member 8 can be inserted into the cylindrical portion 5a together with the adjuster 7.

When the ring 8a comes into contact with the side surface at the upper side of the first groove portion 8b11 in FIG. 2, makes it impossible to further push the stopper 8b into the cylindrical portion 5a, and then stops pushing the stopper 8b, the stopper 8b is pushed upward with respect to the cylindrical portion 5a together with the adjuster 7 by the biasing force of the suspension spring 4, and the ring 8a is inserted into the second groove portion 8b12 of the annular recess portion 8b1. Since the depth of the second groove portion 8b12 is less than the wire diameter of the ring 8a, when the ring 8a is inserted into the second groove portion 8b12, and the inner circumference of the ring 8a comes into contact with the bottom portion of the second groove portion 8b12, reduction of the diameter of the ring 8a is regulated, and the ring 8a is maintained in a state where the outer circumference of the ring 8a protrudes more in the radial direction than the outer circumference of the stopper 8b.

Consequently, in a state where the ring 8a is inserted into the second groove portion 8b12, even when an external force applies to the ring 8a a force in a direction to reduce the diameter, the ring 8a protrudes more in the radial direction than the outer circumference of the stopper 8b, is maintained in a state where the ring 8a is inserted into the annular groove 5a5, and is prevented from being detached from the annular groove 5a5. Consequently, the stopper member 8 is prevented from being detached from the cylindrical portion 5a, so that it is possible to prevent detachment of the adjuster 7.

Note that, when the ring 8a faces the annular groove 5a5, and when the diameter of the ring 8a expands and the ring 8a enters the annular groove 5a5, a hitting sound is generated, so that, when placing the stopper member 8 in the cylindrical portion 5a, an assembly worker can recognize completion of placement of the ring 8a in the annular groove 5a5 according to whether or not the hitting sound is made. However, when the stopper 8b is inserted into the large-diameter portion 5a3 until the stopper 8b cannot be further pushed into the cylindrical portion 5a, the stopper 8b enters beyond a position at which the ring 8a faces the annular groove 5a5, so that it is possible to prevent misplacement of the ring 8a in the annular groove 5a5.

When the ring 8a is inserted into the annular groove 5a5 and is inserted into the second groove portion 8b12 of the stopper 8b, the heights of the upper end surface of the stopper 8b in FIG. 2 and the upper end surface of the cylindrical portion 5a become just the same, and the upper end surface of the stopper 8b and the upper end surface of the cylindrical portion 5a become flush with each other. As described above, the upper end surface of the stopper 8b in FIG. 2 and the upper end surface of the cylindrical portion 5a are set to be flush with each other when the ring 8a is inserted into the annular groove 5a5 and into the second groove portion 8b12, so that the assembly worker can determine whether or not the ring 8a is appropriately placed in the cylindrical portion 5a and the stopper 8b according to a state of the position of the upper end surface of the stopper 8b in FIG. 2 and the position of the upper end surface of the cylindrical portion 5a. Consequently, the upper end surface of the stopper 8b in FIG. 2 and the upper end surface of the cylindrical portion 5a are set to be flush with each other when the ring 8a is inserted into the annular groove 5a5 and into the second groove portion 8b12, so that it is possible to determine whether or not there is an assembly failure of the stopper member 8 by checking from the outside the heights of the stopper 8b and the cylindrical portion 5a.

Furthermore, when the stopper member 8 is placed in the cylindrical portion 5a, the adjuster 7 is positioned in the axial direction by the stopper member 8 at a position at which the lower end surface of the stopper 8b comes into contact with the end surface 7b2 on the opposite shaft portion side of the flange portion 7b of the adjuster 7. As described above, the position at which the adjuster 7 is positioned by the stopper member 8 with respect to the cylindrical portion 5a of the cap 5 becomes an appropriate position of the adjuster 7 with respect to the cylindrical portion 5a. Furthermore, the lower end surface of the stopper 8b and the end surface 7b2 on the opposite shaft portion side of the flange portion 7b of the adjuster 7 are orthogonal surfaces orthogonal to the axis of the adjuster 7, so that the adjuster 7 can smoothly rotate in the circumferential direction at the positioned position, and is prevented by the stopper member 8 from being detached from the cylindrical portion 5a.

Note that, although the first groove portion 8b11 in the annular recess portion 8b1 of the stopper 8b of the stopper member 8 may be formed up to the upper end of the stopper 8b, an annular pocket is formed between the inner circumference of the large-diameter portion 5a3 of the cylindrical portion 5a and the outer circumference of the stopper 8b in this case. In this case, an annular lid that is placed on the pocket and prevents dust and the like from staying in the pocket may be provided.

Next, the suspension spring 4 is interposed between the rod guide 10h of the damper cartridge 10 and the washer 6, and constantly biases the vehicle body side tube 3a and the axle side tube 3b in a direction in which the vehicle body side tube 3a and the axle side tube 3b are apart from each other in the axial direction. Hence, the tube member 3 is biased in a direction in which the tube member 3 is stretched by the elastic force of the suspension spring 4.

Furthermore, when the user of the front fork 1 grips the operation portion 7c1 of the adjuster 7 using the tool and performs the rotation operation, the washer 6 screwed to the outer circumference of the shaft portion 7a is regulated by the cylindrical portion 5a from rotating, and therefore is displaced in the upper/lower direction that is the axial direction in the manner of a feed screw. As described above, when the washer 6 is moved in the upper/lower direction with respect to the cylindrical portion 5a of the cap 5 by the rotation operation of the adjuster 7, the support position of the upper end of the suspension spring 4 also changes accompanying displacement of the washer 6, so that it is possible to adjust the vehicle height of the straddle vehicle to which the front fork 1 is applied.

As described above, the front fork 1 includes: the fork main body 2 that includes the tube member 3 formed by slidably fitting the vehicle body side tube 3a and the axle side tube 3b, and the suspension spring 4 that biases the tube member 3 in the stretching direction; the cap 5 that includes the cylindrical portion 5a inserted into the vehicle body side tube 3a and including the opening 5a6 at the side portion on the distal end side, and the annular lid portion 5b continuing to the outer circumference of the cylindrical portion 5a and placed in the end portion of the vehicle body side tube 3a, and that closes the opening end of the vehicle body side tube 3a; the washer 6 that includes the nut portion 6a having the annular shape, inserted into the cylindrical portion 5a, and including the screw portion 6al on the inner circumference, and the arm portion 6b that extends from the outer circumference of the nut portion 6a, protrudes to the outside of the cylindrical portion 5a through the opening 5a6, and supports the upper end of the suspension spring 4; the adjuster 7 that includes the shaft portion 7a including the screw groove 7al formed on the outer circumference and screwed to the nut portion 6a, the flange portion 7b provided at the rear end of the shaft portion 7a, and the operation shaft portion 7c extending from the opposite shaft portion side of the flange portion 7b and including the operation portion 7c1 at the distal end, and that is inserted into the cylindrical portion 5a of the cap 5 from the side of the shaft portion, is rotatable in the circumferential direction with respect to the cap 5, and causes the operation portion 7c1 to protrude upward from the cylindrical portion 5a; and the stopper member 8 that is placed on the inner circumference of the cylindrical portion 5a of the cap 5, and comes into contact with the opposite shaft portion side of the flange portion 7b to prevent the adjuster 7 from being detached from the cap 5.

In the front fork 1 formed as described above, the cap 5 is formed by only one part instead of two parts, and the stopper member 8 that prevents the adjuster 7 from being detached from the cap 5 is placed on the inner circumference of the cylindrical portion 5a of the cap 5, and comes into contact with the opposite shaft portion side of the flange portion 7b. Consequently, the cap 5 is not formed by the two parts that are mutually subjected to thread fastening, but is formed by the one part, and there is no thread fastening portion at which the two parts are subjected to thread fastening, so that the position of the opening 5a6 through which the arm portion 6b of the washer 6 is inserted can be arranged above compared to the conventional front fork.

As described above, by arranging the position of the opening 5a6 in the cap 5 upward, it is possible to shift the support position on the upper side of the suspension spring 4 supported by the arm portion 6b of the washer 6 upward compared to the conventional front fork, so that it is possible to shorten the entire length of the cap 5 by this shift amount, and increase the axial length (storage length) in the space in which the suspension spring 4 is installed in the front fork 1. As described above, it is possible to increase the storage length of the suspension spring 4, so that the degree of setting freedom of parameters of design of the suspension spring 4 such as the thickness of the wire diameter, the natural length, and the pitch of the suspension spring 4 improves. As described above, according to the front fork 1 according to the present embodiment, it is possible to shorten the entire length of the cap 5, and improve the degree of design freedom of the suspension spring 4.

Furthermore, according to the front fork 1 formed as described above, it is possible to shorten the entire length of the cap 5, and reduce the weight of the cap 5, so that it is possible to reduce the weight of the front fork 1.

Furthermore, in the front fork 1 according to the present embodiment, the stopper member 8 is placed on the inner circumference of the opening end of the cylindrical portion 5a. According to the front fork 1 formed as described above, the adjuster 7 can be disposed above the cylindrical portion 5a, so that it is possible to further shorten the entire length of the cap 5, and further improve the degree of design freedom of the suspension spring 4.

Furthermore, in the front fork 1 according to the present embodiment, the stopper member 8 includes the ring 8a that is inserted into the annular groove 5a5 provided on the inner circumference of the cylindrical portion 5a, and the stopper 8b that has an annular shape, is inserted between the cylindrical portion 5a and the operation shaft portion 7c, is regulated by the ring 8a from moving upward with respect to the cylindrical portion 5a, and comes into contact with the opposite shaft portion side of the flange portion 7b. According to the front fork 1 formed as described above, the end surface 7b2 on the opposite shaft portion side of the flange portion 7b of the adjuster 7 and the end surface on the tubular body side of the stopper 8b come into surface contact with each other, so that the adjuster 7 can smoothly rotate when the adjuster 7 is operated to rotate. Note that, although the stopper member 8 only needs to be placed on the inner circumference of the cylindrical portion 5a so as to be able to prevent the adjuster 7 from being detached from the cylindrical portion 5a, and therefore may be formed by only the C-shaped ring 8a, resistance at a time when the adjuster 7 is operated to rotate becomes higher than that in a case where the stopper 8b is placed into surface contact with the flange portion 7b.

Furthermore, in the front fork 1 according to the present embodiment, the stopper 8b includes the annular recess portion 8b1 that accommodates the ring 8a on the outer circumference, and the annular recess portion 8b1 includes the first groove portion 8b11 that has the inner diameter smaller than the inner diameter of the ring 8a and has the depth equal to or larger than the wire diameter of the ring 8a, and the second groove portion 8b12 that is adjacent to the lower side of the first groove portion 8b11 and has the depth less than the wire diameter of the ring 8a.

According to the front fork 1 formed as described above, when the stopper member 8 is inserted into the annular gap between the cylindrical portion 5a and the operation shaft portion 7c, it is possible to accommodate the ring 8a in the first groove portion 8b11 without interfering with insertion of the stopper 8b into the annular gap. Furthermore, according to the front fork 1 formed as described above, after the ring 8a is placed in the annular groove 5a5, it is possible to insert the ring 8a into the second groove portion 8b12 to constrain such that that the outer diameter of the ring 8a does not become the inner diameter of the large-diameter portion 5a3 or less, and prevent the ring 8a from being detached from the annular groove 5a5.

Furthermore, in the front fork 1 according to the present embodiment, the inner circumference of the stopper 8b is slidably in contact with the outer circumference of the operation shaft portion 7c, and the outer circumference of the stopper 8b is slidably in contact with the inner circumference of the cylindrical portion 5a. According to the front fork 1 formed as described above, the annular gap between the cylindrical portion 5a and the adjuster 7 can be filled with the stopper 8b, so that it is possible to improve the appearance of the surroundings of the adjuster 7, and prevent entry of dust or the like into the annular gap.

Furthermore, in the front fork 1 according to the present embodiment, the upper end surface of the stopper 8b and the upper end surface of the cylindrical portion 5a are flush with each other in the state where the ring 8a is inserted into the annular groove 5a5. According to the front fork 1 formed as described above, after the stopper member 8 is placed in the cap 5, it is possible to check whether or not the position of the upper end surface of the stopper 8b and the position of the upper end surface of the cylindrical portion 5a are flush with each other, and determine from the outside whether or not there is an assembly failure of the stopper member 8.

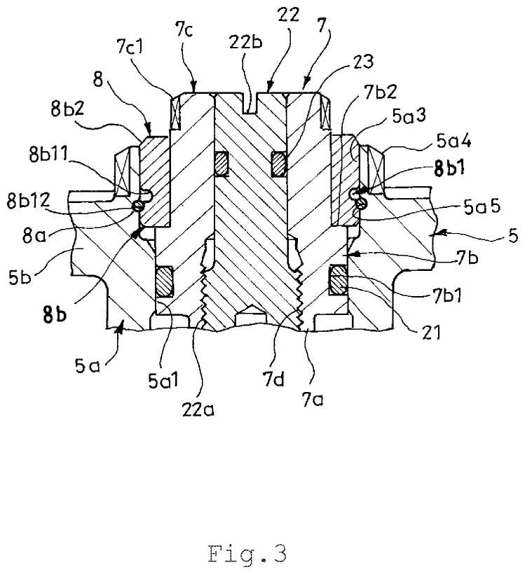

Note that, although the upper end surface of the stopper 8b and the upper end surface of the cylindrical portion 5a are flush with each other in the state where the ring 8a is inserted into the annular groove 5a5 as described above, the upper end of the stopper 8b may protrude above the cylindrical portion 5a as illustrated in FIG. 3. In this case, a chamfered portion 8b2 is provided in a tapered shape on the outer circumference of the upper end of the stopper 8b, and the position of the lower end of the chamfered portion 8b2 is arranged at the same height as that of the position of the upper end surface of the cylindrical portion 5a in a state where the ring 8a is inserted into the annular groove 5a5. Consequently, according to the front fork 1 formed as described above, after the stopper member 8 is placed in the cap 5, it is possible to check whether or not the position of the lower end surface of the chamfered portion 8b2 of the stopper 8b and the position of the upper end surface of the cylindrical portion 5a are the same, and determine from the outside whether or not there is an assembly failure of the stopper member 8. Therefore, to make it possible to determine from the outside whether or not there is the assembly failure of the stopper member 8, it is only necessary to provide a position check means that can visually check the axial position of the stopper 8b with respect to the cylindrical portion 5a. As illustrated in FIG. 3, this position check means is configured by the chamfered portion 8b2 provided on the outer circumference of the upper end of the stopper 8b, yet may be a mark engraved, cut, or coated, and provided on the outer circumference of the stopper 8b when the upper end of the stopper 8b protrudes upward from the cylindrical portion 5a. In the case of the mark, too, when the heights of the position of the mark of the stopper 8b and the position of the upper end of the cylindrical portion 5a are the same, it is possible to check that the ring 8a has been inserted into the annular groove 5a5. Consequently, by providing the position check means that can visually check the axial position of the stopper 8b with respect to the cylindrical portion 5a, it is possible to determine from the outside whether or not there is an assembly failure of the stopper member 8 by checking the heights of the stopper 8b and the cylindrical portion 5a.

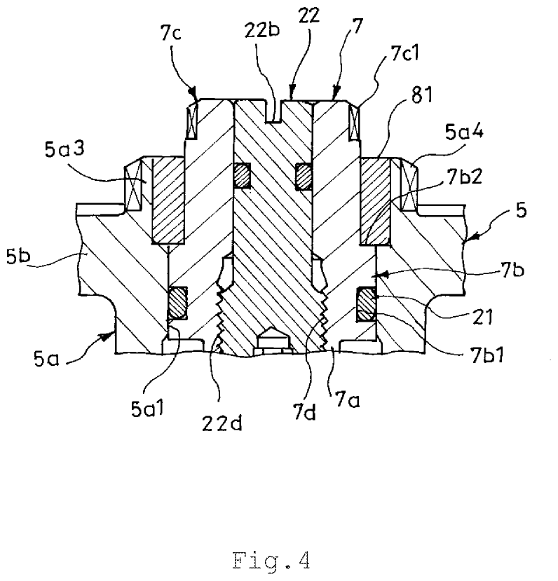

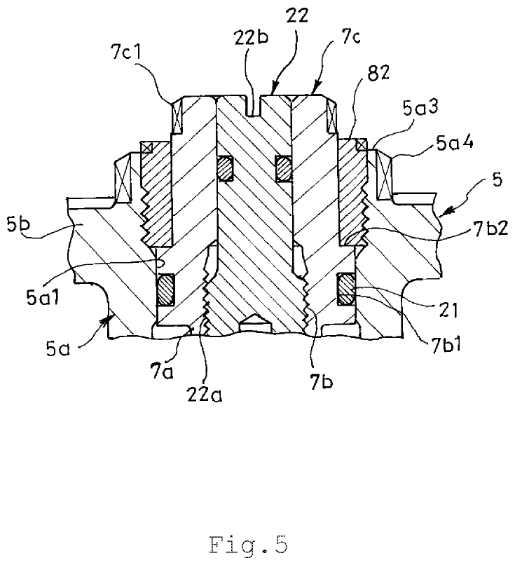

Note that the stopper member 8 may be fixed to the cylindrical portion 5a by press-fitting a stopper member 81 as an annular part having the rectangular cross section to the inner circumference of the large-diameter portion 5a3 of the cylindrical portion 5a as illustrated in FIG. 4 instead of using the ring 8a, or, as illustrated in FIG. 5, the stopper member 82 may be used as an annular part having the rectangular cross section, a screw portion may be provided on the outer circumference of the stopper member 82, and a screw portion may be provided on the inner circumference of the large-diameter portion 5a3 of the cylindrical portion 5a likewise to perform thread fastening on the stopper member 82 to the cylindrical portion 5a. Note that, when the stopper member 82 is subjected to thread fastening to the cylindrical portion 5a, a part that prevents the stopper member 82 from rotating with respect to the cylindrical portion 5a may be provided.

Furthermore, although the front fork 1 according to the present embodiment is provided with the large-diameter portion 5a3 formed by making the diameter of the inner circumference of the upper end of the cylindrical portion 5a of the cap 5 large, the large-diameter portion 5a3 may be omitted by making the inner diameter of the intermediate portion to an upper portion the same. In this regard, by providing the large-diameter portion 5a3, the seal ring 21 placed on the outer circumference of the flange portion 7b of the adjuster 7 does not have to come into contact with the large-diameter portion 5a3 when the adjuster 7 is inserted into the cylindrical portion 5a, so that it is easy to perform work of inserting the adjuster 7 into the cylindrical portion 5a.

Although the preferred embodiment of the present invention has been described above in detail, modifications, variations, and changes can be made thereto without departing from the claims.

### REFERENCE SIGNS LIST

1 FRONT FORK
2 FORK MAIN BODY
3 TUBE MEMBER
3a VEHICLE BODY SIDE TUBE
3b AXLE SIDE TUBE
4 SUSPENSION SPRING
5 CAP
5a CYLINDRICAL PORTION
5a5 ANNULAR GROOVE
5a6 OPENING
5b LID PORTION
6 WASHER
6a NUT PORTION
6b ARM PORTION
7 ADJUSTER
7a SHAFT PORTION
7a1 SCREW GROOVE
7b FLANGE PORTION
7c OPERATION SHAFT PORTION
7c1 OPERATION PORTION
8, 81, 82 STOPPER MEMBER
8a RING
8b STOPPER
8b1 ANNULAR RECESS PORTION
8b11 FIRST GROOVE PORTION
8b12 SECOND GROOVE PORTION

1. A front fork comprising:
a fork main body that includes a tube member that is formed by slidably fitting a vehicle body side tube and an axle side tube, and a suspension spring that biases the tube member in a stretching direction;
a cap that includes a cylindrical portion inserted into the vehicle body side tube and including an opening at a side portion on a distal end side, and an annular lid portion continuing to an outer circumference of the cylindrical portion and placed in an end portion of the vehicle body side tube, and that closes an opening end of the vehicle body side tube;
a washer that includes a nut portion having an annular shape, inserted into the cylindrical portion, and including a screw groove on an inner circumference, and an arm portion that extends from an outer circumference of the nut portion, protrudes to an outside of the cylindrical portion through the opening, and supports an upper end of the suspension spring;
an adjuster that includes a shaft portion including a screw groove formed on an outer circumference and screwed to the nut portion, a flange portion provided at a rear end of the shaft portion, and an operation shaft portion extending from an opposite shaft portion side of the flange portion and including an operation portion at a distal end, and that is inserted into the cylindrical portion of the cap from a side of the shaft portion, is rotatable in a circumferential direction with respect to the cap, and causes the operation portion to protrude upward from the cylindrical portion; and
a stopper member that is placed on an inner circumference of the cylindrical portion of the cap, and comes into contact with the opposite shaft portion side of the flange portion to prevent the adjuster from being detached from the cap.

2. The front fork according to claim 1,
wherein the stopper member is placed on an inner circumference of an opening end of the cylindrical portion.

3. The front fork according to claim 1,
wherein the stopper member includes
a ring that is inserted into an annular groove provided at an inner circumference of the cylindrical portion, and
a stopper that has an annular shape, and that is inserted between the cylindrical portion and the operation shaft portion, is regulated by the ring from moving upward with respect to the cylindrical portion, and comes into contact with the opposite shaft portion side of the flange portion.

4. The front fork according to claim 3, wherein
the stopper has an annular recess portion that accommodates the ring on an outer circumference, and
the annular recess portion includes
a first groove portion that has an inner diameter smaller than an inner diameter of the ring, and has a depth equal to or larger than a wire diameter of the ring, and
a second groove portion that is adjacent to a lower side of the first groove portion, and has a depth less than the wire diameter of the ring.

5. The front fork according to claim 3, wherein
an inner circumference of the stopper is slidably in contact with an outer circumference of the operation shaft portion, and
an outer circumference of the stopper is slidably in contact with the inner circumference of the cylindrical portion.

6. The front fork according to claim 3, further comprising
a position check means that can visually check an axial position of the stopper with respect to the cylindrical portion.

7. The front fork according to claim 5, wherein
an upper end surface of the stopper and an upper end surface of the cylindrical portion are flush with each other in a state where the ring is inserted into the annular groove.

8. The front fork according to claim 7, wherein
the stopper is pushed up by a biasing force of the suspension spring, and the upper end surface of the stopper and the cylindrical portion are flush with each other.
